(19) United States
(12) Patent Application Publication
(10) Pub. No.: US 2010/0088107 A1
(43) Pub. Date: Apr. 8, 2010

(54) PROVIDING CUSTOMIZED MEDICAL INFORMATION

(75) Inventors: Shmuel Ur, Shorashim (IL); Elad Yom-Tov, Mizpe Hoshaya (IL)

Correspondence Address: Ryan, Mason & Lewis, LLP, Suite 205, 1300 Post Road, Fairfield, CT, 06824, US

(73) Assignee: International Business Machines Corporation, Armonk, NY (US)

(21) Appl. No.: 12/246,598

(22) Filed: Oct. 7, 2008

(51) Int. Cl. G06Q 50/00

(52) U.S. Cl. 705/2

(57) ABSTRACT

Techniques for providing temporally-based information to a medical practitioner are provided. The techniques include obtaining temporally-based information, wherein the information comprises medical information derived from the medical practitioner and one or more other medical practitioners, customizing the information for the medical practitioner, wherein customizing the information comprises using one or more diagnoses from the medical practitioner and one or more diagnoses from the one or more other medical practitioners made during a selected temporal period, and providing the information to the medical practitioner. Techniques are also provided for providing temporally-based medical information to an individual.

### FIELD OF THE INVENTION

The present invention generally relates to information technology, and, more particularly, to medical diagnostics.

### BACKGROUND OF THE INVENTION

Today, doctors have to contend with illnesses from all over the world. The spread of disease can be very fast due to international travel and the fast-changing trends in foods and other products. When performing a diagnosis, doctors often take into account diseases that they are familiar with and the diseases that they think are common (for example, to the presenting symptoms). This information can sometimes be enough to correctly diagnose a case, but this certainly does not hold true for all cases. Both a doctor's knowledge of relevant diseases and his or her evaluation of the probable diseases (when diagnosing a patient) can be improved.

By way of example, doctors are known to be influenced by recent cases they have seen, and consequently a rare illness with similar symptoms to a common, recently observed one presents a possibility for misdiagnosis. In the case of the spread of a life-threatening disease, there are a number of institutions dedicated to following it such as, for example, ProMED-mail and Centers for Disease Control and Prevention. Also, there can be models of the spread.

However, the information in such models is macro information and is not often used by individual doctors. It would be advantageous, therefore, if a doctor was given specific information that is relevant to him or her.

### SUMMARY OF THE INVENTION

Principles of the present invention provide techniques for providing customized medical information. An exemplary method (which may be computer-implemented) for providing temporally-based information to a medical practitioner, according to one aspect of the invention, can include steps of obtaining temporally-based information, wherein the information comprises medical information derived from the medical practitioner and one or more other medical practitioners, customizing the information for the medical practitioner, wherein customizing the information comprises using one or more diagnoses from the medical practitioner and one or more diagnoses from the one or more other medical practitioners made during a selected temporal period, and providing the information to the medical practitioner.

In an embodiment of the invention, an exemplary method for providing temporally-based medical information to an individual can include the steps of obtaining temporally-based information, wherein the information comprises medical information derived from the individual and one or more medical practitioners, customizing the information for an individual, wherein customizing the information for an individual comprises incorporating a locality of the individual and medical history of the individual with the medical information, and providing the information to the individual.

One or more embodiments of the invention or elements thereof can be implemented in the form of a computer product including a computer usable medium with computer usable program code for performing the method steps indicated. Furthermore, one or more embodiments of the invention or elements thereof can be implemented in the form of an apparatus or system including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include hardware module(s), software module(s), or a combination of hardware and software modules.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram of an exemplary system on which at least one embodiment of the present invention can be implemented.

FIG. 2 is a flow diagram illustrating techniques for providing temporally-based information to a medical practitioner, according to an embodiment of the present invention;

FIG. 3 is a flow diagram illustrating techniques for providing temporally-based medical information to an individual, according to an embodiment of the present invention; and

FIG. 4 is a system diagram of an exemplary computer system on which at least one embodiment of the present invention can be implemented.

### DETAILED DESCRIPTION OF PREFERRED EMBODIMENTS

Principles of the present invention include an education and alert system for medical practitioners. As used herein, “medical practitioner” refers to any medical professional offering services to a patient (for example, a doctor, nurse, etc.). One or more embodiments of the invention include obtaining information regarding current health-related items that are happening to people and alerting doctors if there is a likely match that he or she is missing. This can be performed, in one or more embodiments of the present invention, based on the doctor's history and/or diagnoses as well as the observations of other doctors.

Such information can be obtained, for example, from a doctor's medical case descriptions, referrals, and feedback given to these referrals. For example, if a doctor refers a patient to a hospital with a diagnosis of influenza, which is then diagnosed as severe acute respiratory syndrome (SARS), one or more embodiments of the invention can “learn” that the latter rare disease can be mistaken for the former common disease. In cases where confidentiality prevents sharing of the information as is, one or more embodiments of the invention can use algorithms to assist in obfuscating the information.

The techniques described herein also include providing information, knowledge and/or alerts to medical practitioners for recent updates with respect to new and old diseases and testing and/or diagnosing procedures. Additionally, one or more embodiments of the invention can include a personalized information service, wherein a doctor is sent information, alerts and/or updates regarding, for example, diseases that are likely to be presented to the doctor which the doctor has not diagnosed before and which may have similar symptoms with other known diseases, efficient tests for the above diseases, etc. For example, such information can include a description of what individuals are likely to have certain diseases, how to differentiate them from other diseases, and how to treat them. The latter information can be obtained from textbooks and/or feedback of treatments to their mis-diagnosed cases, when these have been referred to hospitals, etc.

The information can be customized based on a doctor's preference and/or his history of diagnosis of particular diseases. Further, one or more embodiments of the invention can include the applicability of the techniques described herein to patients who might be in need of medical attention (for example, those with known chronic ailments who are thus more susceptible to certain kinds of diseases), therefore sending information regarding symptoms and/or diagnosis and possible treatment to the patient for immediate attention. Such patients will be able to register to the service described herein based on their current medical diagnosis.

The information used in one or more embodiments of the invention can be based, for example, on spread models with very fine grained knowledge of the spread of a disease (for example, North American Animal Disease Spread Model (NAADSM)). The models can also be based on up-to-date geographical knowledge and diagnostic information from other doctors. For example if another doctor in the city diagnosed a disease X, and this disease is infectious, then other doctors will be informed. This information can be obtained, for example, from referrals, CDC alerts, and/or case reports. The information can also be based, for example, on the history of diagnosis of the specific doctor. For example, a doctor could ask not to receive information about an illness he has diagnosed in the recent past (or other filters, for example, those illnesses that did not appear recently in his geographic neighborhood).

One or more embodiments of the invention can model two aspects of a disease. For example, one aspect can be macro data, based on disease spread model (as noted above), information from the CDC and hospitals, as well as from general practitioners (GPs). Also, another exemplary aspect can include micro data, that is, which diseases are likely to be referred to a specific doctor, which diseases the doctor has recently diagnosed, and which were confirmed or disproved by other doctors later in the process. Additional information can include, for example, the similarity in symptoms and test results for different diseases, as derived from medical literature and previous cases.

Also, the information to be sent to each doctor can be deduced based on the above factors, and analyzed automatically for each subscribing patient. Thus, instead of county-wide information, one or more embodiments of the invention provide an individualized system. The techniques described herein utilize a reinforcement learning paradigm, that is, only a subset of the relevant information may be sent to each doctor and according to feedback from the doctor and his patient records, the information will be improved over time. Such information can often be found, for example, stored in a central repository. If confidentiality issues arise, however, one or more embodiments of the invention can use a privacy preserving algorithm as noted above.

One or more embodiments of the invention can operate in a push or a pull mode. A push mode can include, for example, a customized letter and/or magazine sent to each doctor, describing one or more diseases and how he or she is likely to encounter them. A pull mode can include, for example, when the doctor would like to consult about a case he or she has. Further, when the doctor is putting the finding in, he or she can receive a warning to consider a (or another) disease that fits the finding.

One or more embodiments of the invention can be enhanced to include personalized recommendations. People who choose to participate in the system can enter, for example, their locality (and possibly travel information), risk factors such as family history, medical history, and occupation, as well as fields of interest. Such people can receive personalized alerts when deemed relevant by the system. One or more embodiments of the invention identify relevant alerts by comparing the profile of these people with the profile of the people on which the alert was based. By way of example, these alerts may need a higher threshold of certainty compared to those sent to the doctors, and this can be set as a parameter in one or more embodiments of the invention. Additionally, some people (for example, ones who are traveling and without access to medical treatment) can also be offered ways to identify diseases and possible treatments that can be accessed without professional help. This can be performed as follows. One or more embodiments of the invention can identify a subset of diseases that are likely to occur in the geographic area to which the person is traveling. Also, one or more embodiments of the invention can list possible symptoms from medical textbooks, etc.

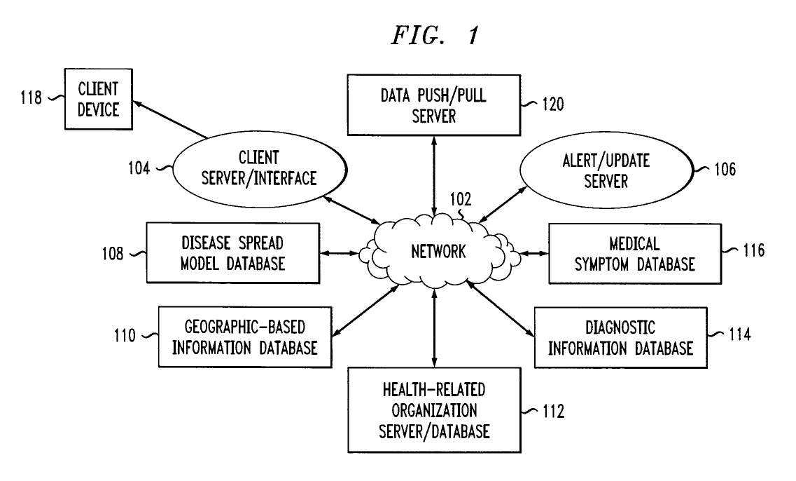

FIG. 1 is a block diagram of an exemplary system on which at least one embodiment of the present invention can be implemented. By way of illustration, FIG. 1 depicts a network 102, a client server and/or interface 104 and an alert and/or update server 106. Also, FIG. 1 depicts a disease spread model database 108, a geographic-based information database 110, a health-related organization server and/or database 112, a diagnostic information database 114 and a medical symptom database 116. Additionally, FIG. 1 depicts a data push/pull server 120 and a client device 118.

In connection with the exemplary system depicted in FIG. 1, one or more embodiments of the invention include an interactive temporal-based diagnosis system, wherein the system includes a push and pull server 120 that interfaces with a network 102 (for example, the internet, a private network, etc.) to provide temporal-based diagnostic information to a client (for example, a medical practitioner). For example, the network 102 customizes temporal-based medical information sought and obtained from a client server 104, a disease spread model database 108, a geographic-based information database 110, a health-related organization server (for example, a CDC database) 112, a diagnostic information database 114, a medical symptom database 116 and an alert server 106 to produce customized temporal-based diagnostic information. Additionally, the network 102 provides the temporal-based diagnostic information to the client. Further, the temporal-based diagnostic medical information can be sent to a client device (such as, for example, a computer, personal digital assistant (PDA), etc.) 118.

It is to be understood that the system depicted in FIG. 1 is exemplary, and that various other changes and modifications may be made to one or more embodiments of the invention, as described herein.

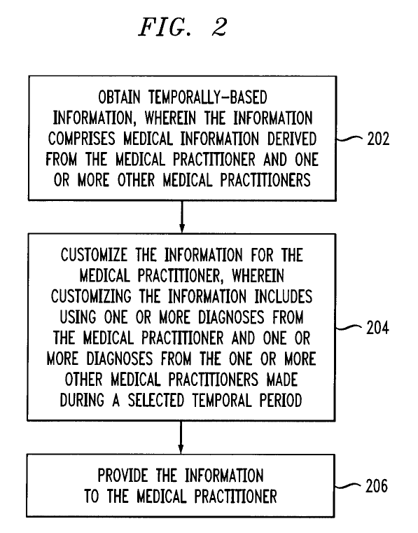

FIG. 2 is a flow diagram illustrating techniques for providing temporally-based information to a medical practitioner, according to an embodiment of the present invention. Step 202 includes obtaining temporally-based information, wherein the information comprises medical information derived from the medical practitioner and one or more other medical practitioners. The medical information can include, for example, updates with respect to diseases, testing procedures and/or diagnostic procedures. Obtaining information can include, for example, obtaining information from a medical practitioner's medical case description, one or more referrals and/or feedback given to the one or more referrals. Obtaining information can also include using one or more privacy preserving algorithms.

Step 204 includes customizing the information for the medical practitioner, wherein customizing the information includes using one or more diagnoses from the medical practitioner (for example, to avoid giving warning on items on which the medical practitioner has recently provided a diagnosis) and one or more diagnoses from the one or more other medical practitioners made during a selected temporal period (for example, the past week, the past month, the past year, etc.). The selected temporal period can include, for example, a period of time selected by the medical practitioner. Customizing the information can also include using geographically relevant diagnoses from medical practitioners, one or more models of disease spread and one or more alerts provided by a health-related organization.

Customizing the information for a medical practitioner can also include using patient information (for example, a patient's weight, family medical history, etc.), a medical practitioner's history, and/or observations of other medical practitioners. Also, using one or more prognoses from the medical practitioner can include implementing a request from the medical practitioner not to receive information about an illness that the medical practitioner has previously diagnosed. Customizing the information for a medical practitioner can additionally include excluding illnesses that did not appear recently in a geographic region of the medical practitioner.

One or more embodiments of the invention also include using information based on spread models with very fine grained knowledge of a spread of a disease and/or spread models based on up-to-date geographical knowledge and diagnostic information from other medical practitioners. Further, customizing information for a medical practitioner can include using a reinforcement learning paradigm to provide only a subset of (relevant) information to the medical practitioner.

Additionally, using alerts provided by a health-related organization can include providing alerts and/or updates regarding diseases that are likely to be presented to the medical practitioner.

Step 206 includes providing the information to the medical practitioner. Providing the information to the medical practitioner can include, for example, providing alerts and/or updates regarding diseases that are likely to be presented to the medical practitioner. Also, providing the information to the medical practitioner can include providing a description of one or more types of individuals that are likely to have a certain diseases, a description of how to differentiate a disease from other diseases, and/or a description of how to treat a disease. One or more embodiments of the invention also include providing a customized letter and/or a customized magazine to the medical practitioner that includes information such as described herein.

Providing the information to the medical practitioner can also include providing information regarding symptoms of the diseases that are likely to be presented to the medical practitioner, as well as information regarding procedures for the diseases that are likely to be presented to the medical practitioner.

The techniques depicted by FIG. 2 can also include, for example, receiving feedback from the medical practitioner to further customize the information to be provided to the medical practitioner, as well as receiving a request from a medical practitioner for a consultation.

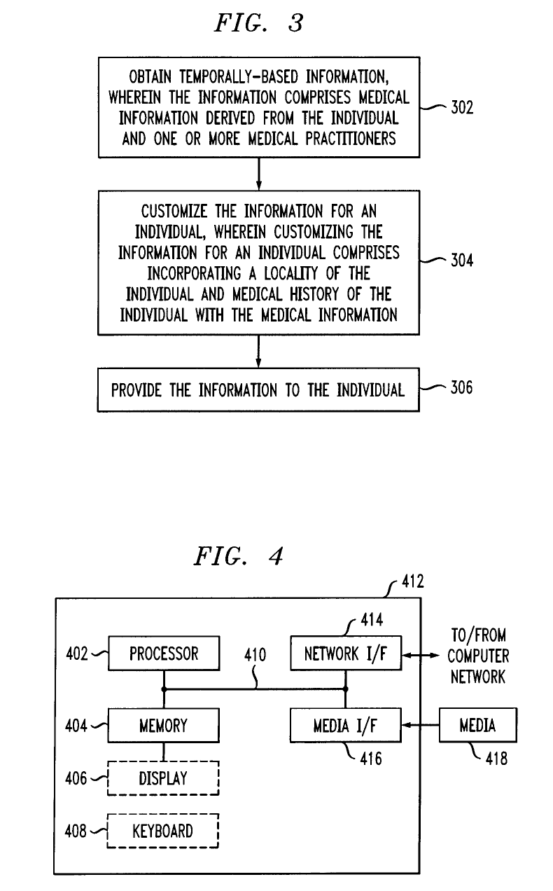

FIG. 3 is a flow diagram illustrating techniques for providing temporally-based medical information to an individual (for example, a patient), according to an embodiment of the present invention. Step 302 includes obtaining temporally-based information, wherein the information comprises medical information derived from the individual and one or more medical practitioners. Step 304 includes customizing the information for an individual, wherein customizing the information for an individual comprises incorporating a locality of the individual and medical history of the individual with the medical information. Customizing the information for an individual can additionally include incorporating travel information of the individual, family history of the individual, occupation of the individual and/or one or more fields of interest of the individual with the medical information.

Step 306 includes providing the information to the individual. Providing the information to the individual can include, for example, providing ways to identify one or more diseases and/or treatments that can be accessed without professional help. Also, providing the information to the individual include identifying relevant alerts by comparing a profile of the individual with profiles of the people on which the alert was based.

The techniques depicted in FIG. 3 can also include, for example, identifying a subset of diseases that are likely to occur in a geographic area to which the individual is traveling and listing one or more possible symptoms.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 4, such an implementation might employ, for example, a processor 402, a memory 404, and an input and/or output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 402, memory 404, and input and/or output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 418) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 404), magnetic tape, a removable computer diskette (for example, media 418), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 402 coupled directly or indirectly to memory elements 404 through a system bus 410. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, customizing information for a medical practitioner using a medical practitioner's history, a medical practitioner's diagnoses and/or observations of other medical practitioners.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for providing temporally-based information to a medical practitioner, comprising the steps of:
obtaining temporally-based information, wherein the information comprises medical information derived from the medical practitioner and one or more other medical practitioners;
customizing the information for the medical practitioner, wherein customizing the information comprises using one or more diagnoses from the medical practitioner and one or more diagnoses from the one or more other medical practitioners made during a selected temporal period; and
providing the information to the medical practitioner.

2. The method of claim 1, wherein the medical information comprises at least one of one or more updates with respect to one or more diseases, one or more testing procedures and one or more diagnostic procedures.

3. The method of claim 1, wherein customizing the information for the medical practitioner further comprises using at least one of patient information, the medical practitioner's history and one or more observations of one or more other medical practitioners.

4. The method of claim 1, wherein using one or more diagnoses from the medical practitioner comprises implementing a request from the medical practitioner not to receive information about an illness that the medical practitioner has previously diagnosed during a selected temporal period.

5. The method of claim 1, wherein customizing the information for the medical practitioner further comprises using at least one of one or more models of disease spread and one or more alerts provided by a health-related organization.

6. The method of claim 5, wherein using one or more models of disease spread comprises using information based on one or more spread models based on up-to-date geographical knowledge and diagnostic information from one or more other medical practitioners.

7. The method of claim 1, wherein providing the information to the medical practitioner comprises providing information regarding one or more symptoms of one or more diseases that are likely to be presented to the medical practitioner.

8. The method of claim 1, wherein providing the information to the medical practitioner comprises providing information regarding one or more procedures for one or more diseases that are likely to be presented to the medical practitioner.

9. The method of claim 1, wherein providing the information to the medical practitioner comprises providing at least one of a description of one or more types of individuals that are likely to have a certain diseases, a description of how to differentiate a disease from one or more other diseases, and a description of how to treat a disease.

10. The method of claim 1, wherein customizing the information for a medical practitioner further comprises using a reinforcement learning paradigm to provide only a subset of information to the medical practitioner.

11. The method of claim 1, further comprising receiving feedback from the medical practitioner to further customize the information to be provided to the medical practitioner.

12. The method of claim 1, wherein providing the information to the medical practitioner comprises providing at least one of a customized letter and a customized magazine to the medical practitioner.

13. The method of claim 1, further comprising receiving a request from a medical practitioner for a consultation.

14. The method of claim 1, wherein obtaining information comprises obtaining information from at least one of the medical practitioner's medical case description, one or more referrals and feedback given to the one or more referrals.

15. The method of claim 1, wherein obtaining information comprises using one or more privacy preserving algorithms.

16. The method of claim 1, wherein customizing the information for a medical practitioner further comprises excluding illnesses that did not appear recently in a geographic region of the medical practitioner.

17. The method of claim 1, wherein the selected temporal period comprises a period of time selected by the medical practitioner.

18. A method for providing temporally-based medical information to an individual, comprising the steps of:
obtaining temporally-based information, wherein the information comprises medical information derived from the individual and one or more medical practitioners;
customizing the information for an individual, wherein customizing the information for an individual comprises incorporating a locality of the individual and medical history of the individual with the medical information; and
providing the information to the individual.

19. The method of claim 18, wherein customizing the information for an individual further comprises incorporating at least one of travel information of the individual, family history of the individual and occupation of the individual with the medical information.

20. The method of claim 18, wherein providing the information to the individual comprises providing at least one of one or more ways to identify one or more diseases and one or more treatments that can be accessed without professional help.

21. The method of claim 18, further comprising identifying a subset of one or more diseases that are likely to occur in a geographic area to which the individual is traveling and listing one or more possible symptoms.

22. The method of claim 18, wherein providing the information to the individual comprises identifying one or more relevant alerts by comparing a profile of the individual with one or more additional profiles of the people on which the alert was based.

23. A computer program product comprising a computer readable medium having computer readable program code for providing temporally-based information to a medical practitioner, said computer program product including:
computer readable program code for obtaining temporally-based information, wherein the information comprises medical information derived from the medical practitioner and one or more other medical practitioners;
computer readable program code for customizing the information for the medical practitioner, wherein customizing the information comprises using one or more diagnoses from the medical practitioner and one or more diagnoses from the one or more other medical practitioners made during a selected temporal period; and
computer readable program code for providing the information to the medical practitioner.

24. An apparatus for providing temporally-based information to a medical practitioner, comprising:
a memory; and
at least one processor coupled to said memory and operative to:
obtain temporally-based information, wherein the information comprises medical information derived from the medical practitioner and one or more other medical practitioners;
customize the information for the medical practitioner, wherein customizing the information comprises using one or more diagnoses from the medical practitioner and one or more diagnoses from the one or more other medical practitioners made during a selected temporal period; and
provide the information to the medical practitioner.

25. An interactive temporal-based diagnosis system, wherein the system comprises a push and pull server that interfaces with a network to provide temporal-based diagnostic information to a client, wherein the network customizes temporal-based medical information obtained from a client server, a disease spread model database, a geographic-based information database, a health-related organization server, a diagnostic information database, a medical symptom database and an alert server to produce customized temporal-based diagnostic information, and wherein the network provides the temporal-based diagnostic information to the client.
